(19) United States
(12) Patent Application Publication
(10) Pub. No.: US 2025/0045641 A1
(43) Pub. Date: Feb. 6, 2025

(54) COMPUTING INSTANCE RECOMMENDATIONS FOR MACHINE LEARNING WORKLOADS

(71) Applicant: Adobe Inc., San Jose, CA (US)

(72) Inventors: Kanak MAHADIK, San Jose, CA (US); Jashwant Raj GUNASEKARAN, Sunnyvale, CA (US); Haoliang WANG, Sunnyvale, CA (US); Vani NAGARAJAN, West Lafayette, IN (US)

(21) Appl. No.: 18/229,593

(22) Filed: Aug. 2, 2023

(51) Int. Cl. G06N 20/20

(52) U.S. Cl. CPC G06N 20/20

(57) ABSTRACT

In various examples, a prediction machine learning model determines a set of computing instances capable of executing a machine learning model and a set of batch sizes associated with inferencing requests based on a set of model parameters associated with the machine learning model and a number of floating point operations (FLOPS). In such examples this information is used to update a user interface to indicate computing instances to perform inferencing operations.

### BACKGROUND

Cloud computing services are frequently relied on to provide computing resources (e.g., virtual machines, storage, etc.) during training and/or implementation of artificial intelligence (AI) models. Oftentimes, cloud computing services provide access to a large number of computing instances with various configurations that can be used to train and/or implement AI models. For instance, a cloud computing service may allow selection of various configurations of a computing instance including, for example, a number of CPUs, a type of CPU, a number of GPUs, a type of GPU, a type of CPU memory, an amount of CPU memory, a type of GPU memory, an amount of GPU memory, or other aspects of the computing instance. Different computing instance configurations, however, generally correspond with different latencies (e.g., processing time) when servicing inferencing requests. As such, selecting a computing instance for a particular inference service can be resource intensive and inaccurate.

### SUMMARY

Embodiments described herein generally relate to a machine learning model which predicts latency and/or other metrics of inferencing services executing on different computing instances and/or using different batch sizes. In accordance with some aspects, the systems and methods described are directed to training a prediction machine learning model that predicts various outcomes and/or attributes of executing inferencing operations using various computing instances and various batch sizes. Based on the predicted outcomes (e.g., latency), a particular computing instance and/or batch size can be selected for utilization by an inferencing service. Further such a prediction machine learning model is capable of generating predictions for new or otherwise unpredictable service requests (e.g., request to perform inferencing using a machine learning model). For example, inferencing requests can fluctuate over time with rapid increases and decreases in the number of requests. The prediction machine learning model, as described herein, can predict the latency associated with these unpredictable workloads and indicate an optimal batch size to reduce the cost and/or latency associated with servicing the requests.

Furthermore, in various examples, the prediction machine learning model is trained to predict latency (e.g., an amount of time taken to process a set of inferencing requests and/or workload) associated with various types of computing instances and various different batch sizes. In one example, the prediction machine learning model training using training data collection from the various types of computing instances during processing of inferencing requests. Continuing the example, once trained, the prediction machine learning model generates latency prediction based on various attributes of a machine learning model to be used to perform inferencing (e.g., the inferencing service). For instance, the prediction machine learning model can take as an input the model parameters and number of floating point operations (FLOPs) and predict the latency for a set of computing instances and batch sizes. In one example, a weighted sum is determined to the output of the prediction machine learning model and a computing instance type and batch size is selected based on the result. In addition, in various examples, this process is repeated periodically or aperiodically (e.g., at the termination of a five minute sliding window) based on a forecast indicating an expected number of inferencing request over an interval of time.

### BRIEF DESCRIPTION OF THE DRAWINGS

The present invention is described in detail below with reference to the attached drawing figures, wherein:

FIG. 1 depicts an environment in which one or more embodiments of the present disclosure can be practiced.

FIG. 2 depicts an environment in which a prediction machine learning model is trained to predict latency information associated with processing inferencing requests, in accordance with at least one embodiment.

FIG. 3 depicts an environment in which a prediction machine learning model predicts latency information associated with processing inferencing requests, in accordance with at least one embodiment.

FIG. 4 depicts an example process flow for predicting latency information using a prediction machine learning model, in accordance with at least one embodiment.

FIG. 5 depicts an example process flow for selecting computing instances and/or batch sizes for processing inferencing requests using a prediction machine learning model, in accordance with at least one embodiment.

FIG. 6 depicts an example process flow for generating a training dataset to train a prediction machine learning model, in accordance with at least one embodiment.

FIG. 7 is a block diagram of an exemplary computing environment suitable for use in implementations of the present disclosure.

### DETAILED DESCRIPTION

Inference services generally enable execution of a trained AI model(s) to make predictions or inferences. In many cases, a computing instance (e.g., a CPU, GPU, or a virtual machine) is utilized to provide inference services. Generally, inference services include latency requirements and/or cost specifications such that the inference services are performed in an efficient and effective manner. However, with a large variety of computing instances available, it is difficult to select the most appropriate computing instance that meets the latency requirement and minimizes cost.

For example, in some implementations, computing resource service providers (e.g., cloud computing services) provide access to a variety of different computing instances and computing instance configurations. When creating the computing instance, the user can select from a number of different types of processors including graphics processors accessible to the computing instance. For instance, the computing resource service provider allows the user to select various configurations of the computing instance including a number of CPUs, a type of CPU, a number of GPUs, a type of GPU, a type of CPU memory, an amount of CPU memory, a type of GPU memory, an amount of GPU memory, or other aspects of the computing instance. However, different computing instance configurations, for example, have different latencies (e.g., processing time) when servicing inferencing requests. In addition, computing instances with access to more computing resources, in some examples, do not perform better than computing instances with access to less computing resources. Furthermore, different batch sizes produce different latency results based on time and/or cost associated with instantiating various computing instances. As a result, in such examples, selecting an optimum computing instance configuration for providing an inferencing service can be difficult and time consuming for users. In addition, other solutions are unable to support ad-hoc implementations that can optimize latency and/or cost when servicing unpredictable workloads.

One manner for identifying or selecting an appropriate computing instance includes running an inference service on each available instance to analyze the corresponding latency and performance numbers to select a computing instance. Such an implementation, however is very expensive and time consuming.

As such, in some cases, a computing instance is selected based on a particular attribute. For instance, assume a production inference service runs on a cloud instance and that hundreds of different instance types with varying numbers of CPUs, GPUs, and available memory exist. With the variety of available options, a user may select a most or least expensive instance or initiate inference performance on a few instances and select the computing instance with the best performance. Alternatively, a user may randomly select a computing instance for utilization. Such approaches, however, do not take into account characteristics of the model and instances and, as a result, generally lead to suboptimal performance.

Another conventional approach requires performing inferencing on a representative workload. In such an approach, the inference service needs to be performed on multiple computing instances and, thereafter, logged performance statistics are used to create a regression model that can predict performance. Such an implementation, however, results in unnecessary costs and latency due to the performance of the inference services, among other things. Further, such an approach lacks analysis of dynamic batch variation, thereby preventing it from dynamically reacting to workload fluctuations.

Accordingly, embodiments described herein generally relate to computing instance recommendations for machine learning workloads. In this regard, embodiments facilitate optimization of inference services by, among other things, identifying appropriate or optimal computing instance and dynamic batch size variation. Stated differently, embodiments facilitate selecting computing instance types and batch size for an inference service to reduce latency and cost of production. To do so, aspects described herein are used to predict the latency of an inference service(s) on different computing instances and with different batch sizes (e.g., using a random forest regression model) and, such predictions are used to select a particular computing instance and/or batch size for an inference service. Utilizing dynamic batch size variation enables handling unpredictable workload fluctuations.

At a high level, embodiments described herein are directed to a prediction machine learning model which predicts processing time and/or other latency for any combination of computing instance type, computing instance configuration, workload, batch size, number of inferencing requests, and/or machine learning model. In one example, the prediction machine learning model predicts a set of latencies (e.g., response times) associated with a set of computing instances executing the machine learning model to process inferencing requests for various batch sizes. In accordance with some aspects, the systems and methods described are directed to training the prediction machine learning model which is capable of predicting latency information associated with executing various machine learning workloads (e.g., performing inferencing using a particular machine learning model) using various types of computing instances and different batch sizes for submitting inferencing requests. In addition, in various embodiments, a latency tool, which provides users access to the prediction machine learning model, obtains requests forecasts indicating a number of inferencing requests expected over an interval of time and determines a type of computing instance and/or batch size to optimize (e.g., reduce) latency and/or cost associated with processing inferencing requests. For example, the prediction machine learning model predicts latency information, filters the latency information based on a latency upper bound provided by a user, and determines a computing instance and batch size for processing inferencing requests based on a forecasted number of inferencing requests that reduces the latency and/or cost associated with processing the inferencing requests.

Furthermore, in various embodiments, the prediction machine learning model is trained to predict or otherwise generate latency information based on training data collected from inferencing operations and/or inferencing services. In one example, the training data includes latency times associated with various computing instance types used to process inferencing requests of various batch sizes. Continuing with this example, the various computing instance types are used to execute a machine learning model (e.g., object detection model, large language model, generative model, etc.) and latency information is obtained for processing inferencing requests of various batch sizes (e.g., the number of requests included in an inferencing request) and included in a training dataset. In an embodiment, the training dataset include latency information (e.g., an amount of time taken to process a particular inferencing request), model parameters, number of floating point operations (FLOPs), batch size, and computing instance information (e.g., a number of central processing units (CPUs), a type of CPU, a number of graphics processing units (GPUs), a type of GPU, a type of CPU memory, an amount of CPU memory, a type of GPU memory, an amount of GPU memory, or other aspects of the computing instance).

Furthermore, in various embodiments, the prediction machine learning model allows the user to balance latency and cost for different workloads (e.g., by selecting different instance configurations offered by the computing resource service provider and batch sizes). For example, a user can indicate weight values to be applied to cost and/or latency information predicted by the prediction machine learning model. In various embodiments, the prediction machine learning model generates an output (e.g., in the form of a table) indicating instance configurations, batch size, and latency information. In one example, the output is filtered based on a latency upper bound provided by the user, and the weighted sums of the table values (e.g., based on the weight values provided by the user) are determined. Continuing with this example, the resulting values are used to select a computing instance type and/or configuration and a batch size for processing inference requests (e.g., by instantiating one or more computing instances to provide an inferencing service).

During training, in an embodiment, the prediction machine learning model is trained using data collected from a plurality of computing instances executing a plurality of machine learning models processing inferencing requests. In one example, the training dataset includes information associated with the machine learning model such as model type, number of FLOPs, model parameters, number of layers, inferencing operation type, and/or other information associated with the machine learning model. In another example, the training dataset includes information associated with the computing instance executing the machine learning model such as configuration information, latency information, cost, computing resources available, and/or other information associated with the computing instance. In various embodiments, the prediction machine learning model includes a regression model (e.g., random forest regression model) trained using the training dataset to predict latency information. In an embodiment, the prediction machine learning model takes as an input a model parameters and FLOPs and predicts the latency information for the plurality of computing instances given various batch sizes.

Advantageously, aspects of the technology described herein enable handling of unpredictable workloads and implementation of ad-hoc inferencing services in an efficient and effective manner. Furthermore, the prediction machine learning model enables optimization of cost and/or latency over a plurality of different sliding windows (e.g., intervals of time) for various different computing instances.

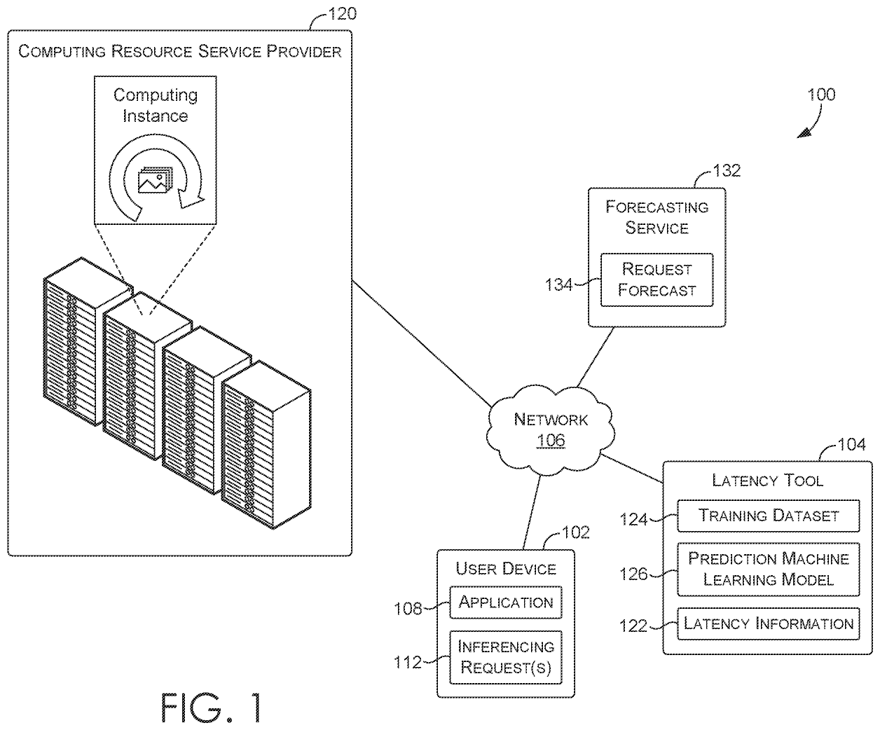

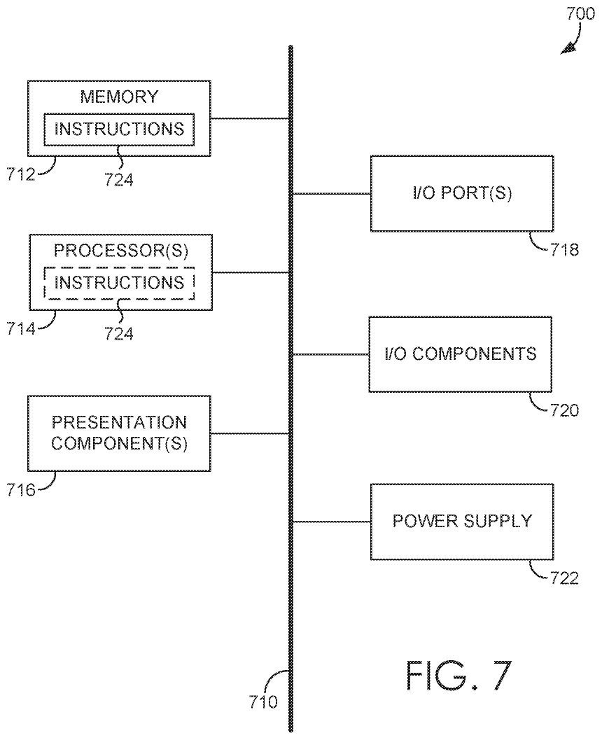

Turning to FIG. 1, FIG. 1 is a diagram of an operating environment 100 in which one or more embodiments of the present disclosure can be practiced. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 7.

It should be understood that operating environment 100 shown in FIG. 1 is an example of one suitable operating environment. Among other components not shown, operating environment 100 includes a user device 102, latency tool 104, a network 106, and forecasting service 132. Each of the components shown in FIG. 1 can be implemented via any type of computing device, such as one or more computing devices 700 described in connection with FIG. 7, for example. These components can communicate with each other via network 106, which can be wired, wireless, or both. Network 106 can include multiple networks, or a network of networks, but is shown in simple form so as not to obscure aspects of the present disclosure. By way of example, network 106 can include one or more wide area networks (WANs), one or more local area networks (LANs), one or more public networks such as the Internet, and/or one or more private networks. Where network 106 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 106 is not described in significant detail.

It should be understood that any number of devices, servers, and other components can be employed within operating environment 100 within the scope of the present disclosure. Each can comprise a single device or multiple devices cooperating in a distributed environment. For example, the latency tool 104 and the forecasting service 132 can include multiple server computer systems cooperating in a distributed environment to perform the operations described in the present disclosure.

User device 102 can be any type of computing device capable of being operated by an entity (e.g., individual or organization) and obtains data from latency tool 104 and/or a data store which can be facilitated by the latency tool 104 (e.g., a server operating as a frontend for the data store). The user device 102, in various embodiments, has access to or otherwise obtains inferencing requests 112 which includes data (e.g., images, text, etc.) to be processed by a machine learning model executed by a computing instance 128 or other computing device. For example, the application 108 operates an inferencing service the is supported by a machine learning model (e.g., deep learning model, regression model, neural network, etc.) that can be executed by the computing instance 128 of a computing resource service provider 120 to perform and/or process the inferencing requests 112. In various embodiments, the inferencing request 112 includes a task for the machine learning model. For example, the application 108 executes a service frontend and distributes the inferencing request to computing instance 128 for processing by the machine learning model. In yet other embodiments, the inferencing requests 112 includes training tasks for the machine learning model associated with the application 108.

In some implementations, user device 102 is the type of computing device described in connection with FIG. 7. By way of example and not limitation, the user device 102 can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device 102 can include one or more processors, and one or more computer-readable media. The computer-readable media can also include computer-readable instructions executable by the one or more processors. In an embodiment, the instructions are embodied by one or more applications, such as application 108 shown in FIG. 1. Application 108 is referred to as a single application for simplicity, but its functionality can be embodied by one or more applications in practice. In some embodiments, the user device 102 has access to, over the network 106, the computing instance 128 (e.g., virtual machine) executed by computing resources (e.g., server computer systems) provided by a computing resource service provider 120. In one example, the computing resource service provider 120 provides users with access to services, such as a virtual computing service, to enable the user to initiate execution of the application 108 using computing instances provided by the computing resource service provider 120. Furthermore, in various embodiments, the computing resource service provider 120 offers a plurality of different computing instance configurations. In one example, the user can select between different configurations of computing instances including the number and type of processors, size and type of memory, storage, network type, system architecture, operation system, accessible devices, or any other configuration for the computing instance 128.

In various embodiments, the application 108 includes any application capable of facilitating the exchange of information between the user device 102 and the latency tool 104. For example, the application 108 provides the latency tool 104 with information associated with the machine learning model (e.g., the machine learning model to process the inferencing requests 112) and/or computing instances available to execute the application 108, and the latency tool 104 returns latency information 122 based on the prediction machine learning model 126. For example, the latency information 122 indicates a predicted interval of time a computing instances will take to process a batch of data objects using the machine learning model. Furthermore, in some embodiments, the latency information 122 enables the application 108 to determine and/or set a batch size for the inferencing request(s) 112 based on a request forecast 134 obtained from the forecasting service 132.

In some implementations, the application 108 comprises a web application, which can run in a web browser, and can be hosted at least partially on the server-side of the operating environment 100. In addition, or instead, the application 108 can comprise a dedicated application, such as an application being supported by the user device 102 and computing resources of the computing resource service provider 120. In some cases, the application 108 is integrated into the operating system (e.g., as a service). It is therefore contemplated herein that “application” be interpreted broadly.

For cloud-based implementations, for example, the application 108 is utilized to interface with the functionality implemented by the latency tool 104. In some embodiments, the components, or portions thereof, of the latency tool 104 are implemented on the user device 102 or other systems or devices. Thus, it should be appreciated that the latency tool 104, in some embodiments, is provided via multiple devices arranged in a distributed environment that collectively provide the functionality described herein. Additionally, other components not shown can also be included within the distributed environment. Furthermore, while the examples described in connection with FIG. 1 describe computing instances (e.g., virtual machines) provided by the computing resource service provider 120, the latency tool 104, in various embodiments, provides latency information 122 of computing devices such as on-premises server computers, personal computers, laptops, or any other computing device suitable for executing the application 108.

As illustrated in FIG. 1, the latency tool 104 provides the user device 102 with latency information 122 associated with the computing instance 128 used to execute the application 108 or a portion thereof (e.g., a machine learning model component of the inferencing service provided by the application 108) to process the inferencing requests 112. In one example, the inferencing requests 112 includes a batch of images to be processed by a neural network to produce a result. In another example, the inferencing requests 112 includes an audio file to convert into a transcript using a natural language processor. In various embodiments, the inferencing requests 112 includes training and/or inferencing to be performed by the machine learning model associated with the application 108.

In various embodiments, the computing instance 128 includes a GPU which can include various different GPU architectures. Furthermore, in such embodiments, the computing instance 128 is capable of being configured with different numbers of GPUs, different virtual CPUs, different numbers of virtual CPUs, network bandwidth, operating systems, applications, hardware and/or other configurations. The different possible configurations of the computing instance 128, for example, produce different processing time and/or the latency information 122 when executing the application 108 (e.g., providing an inferencing service to process inferencing request using a machine learning model). In addition, in such examples, some configurations to the computing instance 128 include unseen configurations such as new configurations of hardware, software, and/or other configurations for which metrics including processing time and/or the latency information 122 when executing the application 108 are unavailable. In various embodiments, the latency tool 104 predicts various system performance metrics (e.g., latency) for various configurations of the computing instance 128 in order to generate a ranking and/or recommendation associated with inferencing requests. In various embodiments, the latency tool 104 includes a training dataset 124 which is used to train the prediction machine learning model 126.

In some embodiments, the prediction machine learning model 126 generates the latency information 122 for the computing instance 128 when executing or otherwise processing the inferencing requests 112 (e.g., using the application 108) which is used alone or in combination with a request forecast 134 from a forecasting service to recommend or otherwise determine a batch size and/or computing instance configuration (e.g., the computing instance 128) to process the inferencing requests 112. In one example, the user provides information indicating possible configurations of the computing instance 128 and information associated with the machine learning model (e.g., number of layers of the model, number of activations of the model, FLOPs, model parameters, batch size, etc.) and the prediction machine learning model outputs data (e.g., in the form of a table) indicating computing instance configurations, batch size, and/or predicted latency. Continuing with this example, the user, based on the information in the table, can selects a configuration of the computing instance 128 and/or batch size for implementation of an inferencing service using the machine learning model. In addition to or in other examples, as described in more detail below, the forecasting service 132 generates (e.g., using a machine learning model, algorithm, and/or heuristic) the request forecast 134 which predicts or otherwise indicates a number of inferencing requests to be received over an interval of time (e.g., the next five minutes), based on the request forecast 134 and the latency information 122, the latency tool 104 dynamically selects and/or modifies the configuration of the computing instance 128 and/or batch size for implementation of the inferencing service using the machine learning model

The training dataset 124, in an embodiment, includes metrics such as latency obtained from computing instances (e.g., computing instances with a plurality of different configurations) during execution of a plurality of different inferencing tasks using a plurality of different machine learning models. For example, different configurations of computing instances (e.g., processor architecture, number of processors, memory, etc.) are used to execute different workloads (e.g., inferencing operations of transformers, neural networks, regression models, etc. using various batch sizes), and the latency tool 104 obtains metrics generated during execution such as latency, processor utilization, memory utilization, core temperature, network bandwidth, or any other metric collected from a computing instance (e.g., including statistical data such as average, mean, mode, maximum, minimum, etc.). Continuing this example, the metrics collected and stored in the training dataset 124 along with information about the machine learning model, such as parameters, FLOPs, layers, model type, batch size, or other information related to the machine learning model and/or inferencing operations.

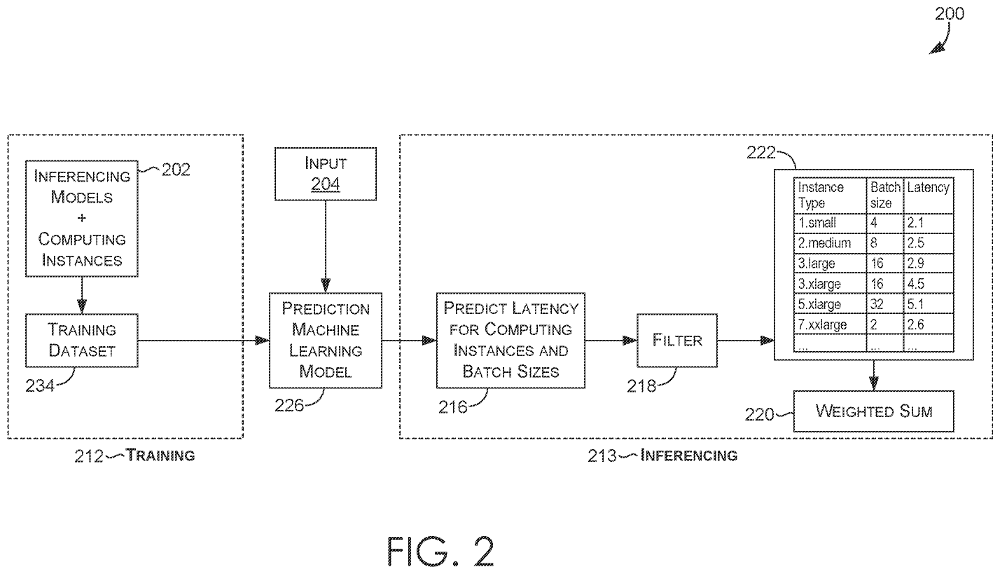

In various embodiments, the prediction machine learning model 126 is trained using the training dataset 124 to predict, during inferencing, various system performance metrics of the computing instance 128 when executing the inferencing requests 112. For example, the prediction machine learning model 126 predicts the latency information 122, utilization, or other metrics. In various embodiments, the prediction machine learning model 126 includes a regression model, a transformer, a neural network, or other any other machine learning model capable of predicting system performance metrics, such as the latency information 122. In one example, during inferencing, the prediction machine learning model 126 takes as an input the a set of possible configurations of the computing instance and information associated with the machine learning model (e.g., number of layers of the model, number of activations of the model, FLOPs, model parameters, batch size, etc.) and outputs data (e.g., in the form of a table) indicating computing instance configurations, batch size, and/or predicted latency as described in greater detail below in connection with FIG. 2.

In various embodiments, the otuput generated by the prediction machine learning model 126 is filtered to remove computing instance configurations with a predicted latency (e.g., in the latency information 122) above a threshold. For example, assume a user provides an upper bound on latency for an inferencing service to be provided by the application 108. In such a case, when selecting the computing instance 128 and/or batch size based on the latency information 122, the latency information 122 can be filtered to remove predicted latency over the upper bound provided by the user. In addition, in various embodiments, the user provides a weighting between latency and cost which is used to determine a weight sum for the latency information 122. For example, the user can select to weight latency greater than cost. This weighting is then used to calculate a weight sum of the latency information when selecting the computing instance 128 and/or batch size for processing the inferencing requests 112.

In various embodiments, the latency information 122 includes the output of the prediction machine learning model 126. In addition, in some embodiments, the latency information 122 includes the output of the prediction machine learning model 126 organized in a particular format, such as a table format. For example, a table can be generated that indicates predicted latencies for various configurations of the computing instance 128 and various batch sizes enabling the user to select a particular configuration of the computing instance 128 and/or batch size for processing inferencing request 112. In other embodiments, the user specifies additional information (e.g., an upper bound on latency and/or a weighting between latency and cost) and, using such information, the latency tool 104 automatically (e.g., without user intervention) selects and/or modifies the computing instance 128 (e.g., configuration of the computing instance 128) and/or batch size. For example, the user can indicate a specific goal or use case, and the latency tool 104 generates the latency information 122 and selects a configurations of the computing instance 128 based on the specific goal or use case. In various embodiments, the latency information 122 is weighted to prioritize or otherwise cause the latency tool 104 to select the combination of computing instance and batch size to achieve the specific goal or user case indicated by the user. For example, the user indicates a goal of reducing the cost of the computing instance while maintaining latency below a threshold. Continuing with this example, for each row of the table in the latency information, a weight sum is calculated or otherwise determined and the highest value is selected.

In various embodiments, the latency tool 104 obtains the request forecast 134 from the forecasting service 132 and, based on the latency information, selects the batch size that achieves the indicated goal or use case. In one example, the latency tool 104 selects the batch size based on the number of expected inferencing requests 112 indicated in the request forecast 134 that reduces latency. Continuing with this example, if request forecast 134 indicates that thirty-two request are predicted in the next interval of time and the latency information 112 indicates that two batches (e.g., a group of inferencing requests and data objects for the computing instance 128 process) of batch size sixteen have a lower latency than one batch of thirty-two, the latency tool 104 selects a batch size of 16 for the next interval of time. In various embodiments, the request forecast 134 indicates a number of expected inferencing request during an interval of time. For example, the request forecast 134 indicates an expected number of inferencing request 134 in the next five minutes. The forecasting service 132, in various embodiments, includes a machine learning model, algorithm, or heuristic to generate the request forecast 134. For example, a machine learning model can take as an input the request history of the application 108 (e.g., the last hour) and generate the request forecast 134.

In various embodiments, the latency tool 104 dynamically varies the computing instance 128 configuration and/or batch size to reduce latency and/or cost based on the number of expected inferencing requests 112 indicated in the request forecast 134. In one example, the latency information 122 indicates predicted latencies for various the batch size and the latency tool 104 selects the batch size produces the lowest predicted latency based on the number of inferencing requests 112 indicated in the request forecast 134. In various embodiment, the latency tool 104 reevaluates the computing instance 128 configuration and/or batch size at the termination of an interval of time (e.g., a five minute sliding window) based on the request forecast 134. For example, the latency tool 104 obtains the request forecast 134 which indicates a number of expected inferencing requests 122 in the next five minutes and selects the computing instance 128 configuration and/or batch size for the application 108. Continuing this example, after the expiration of the five minutes, the latency tool obtains another request forecast 134 which indicates a number of expected inferencing requests 122 for the next five minutes. This process, in various embodiments, continues without user intervention and reduces the latency of the application 108 in servicing or otherwise processing inferencing requests 112. Furthermore, in some embodiments, the latency information 122 can be reused (e.g., additional predictions are not generated by the prediction machine learning model 126) by the latency tool 104 for determine the computing instance 128 configuration and/or batch size for various intervals of time (e.g., sliding windows).

FIG. 2 illustrates an environment 200 in which a prediction machine learning model 226 generates latency information 222, in accordance with at least one embodiment. For example, during inferencing 213, the prediction machine learning model 226 predicts latency for computing instances and batch size 216. A filter 218 is then applied to the results (e.g., the results of predicting latency for computing instances and batch size 216), and the latency information 222 is generated based on the filtered results. In an embodiment, the results of predicting latency for computing instances and batch size 216 are generated by the prediction machine learning model 226 using as an input 204. In various embodiments, the input 204 includes a machine learning model and/or information associated with the machine learning model and computing instances available to execute the machine learning model. Furthermore, in various embodiments, the results of predicting latency for computing instances and batch size 216 include a predicted latency (e.g., an amount of time to process an inferencing request) for a particular computing instance and batch size.

In various embodiments, the prediction machine learning model 226 includes a trained regression model to output latency information for a machine learning model processing inferencing requests and executed by a set of computing instances using various batch sizes. As described above, for example, the prediction machine learning model 226 generates a table 222 indicating a latency associated with a particular type of computing instance and a particular batch size. For example, as illustrated in FIG. 2, in the table 222 the instance type “1.small” with a batch size of “4”, has a predicted latency of “2.1.”

In various embodiments, during a training 212 phase, inferencing models and computing instance data 202 is obtained and used to generate a training dataset 234 used to train the prediction machine learning model 226. For example, the inferencing models and computing instance data 202 includes information associated with models performing inferencing operations, such as model parameters, layers, FLOPs, and other information associated with machine learning models. In another example, the computing instance data includes configuration information associated with the computing instances executing the models such as number of CPUs, number of GPUs, type of CPU, type of GPU, amount of memory, type of memory, network bandwidth, and other information associated with computing hardware.

In various embodiments, during an inferencing 213 phase, the input 204 is obtained and the prediction machine learning model 226 predicts latency information for computing instances and batch sizes 216. As mentioned above, in one example, the input 204 include information associated with a model to be used to perform inferencing operations or otherwise provide an inferencing service, a set of possible batch sizes, and the set of possible computing instances types. In various embodiments, the information associated with the model (e.g., model parameters and FLOPs) is provided by the user. In other embodiments, the model is provided and an application, such as the latency tool 104 described above in connection with FIG. 1, determines the information associated with the model. For example, a script or other application can take as an input the model and determine the model parameters and the number of FLOPs.

In various embodiments, the set of possible batch sizes is provided by the user or other entity, such as a computing resource service provider. In one example, the set of possible batch sizes include four, eight, sixteen, and thirty-two, where the batch size indicates the number of data objects (e.g., images, text, files, etc.) that can be included in an inferencing request for processing by the model. In various embodiments, the set of possible computing instances types include computing instance configurations available to execute the machine learning model. For example, the set of possible computing instances types includes computing instances provided by the computing resource service provider.

As described above, in an embodiment, the latency information predicted by the prediction machine learning model 226 is filtered 218 and used to generate the table 222. For example, the user can provide an upper bound (e.g., a threshold latency value) of latency for filtering 218 the results of the prediction machine learning model 226. In another example, the upper bound and/or threshold used to filter 218 the results of the prediction machine learning model 226 is determined based on the inferencing service to be executed (e.g., a service level agreement provided by the inferencing service). In various embodiments, filtering 218 the results includes remove, deleting, or otherwise eliminating predicted latencies above and/or below a threshold value. For example, the table 222 does not include predicted latency values above the threshold value.

In various embodiments, a weighted sum 220 is calculated to determine a computing instance type and/or batch size for executing the inferencing service (e.g., executing the model to service inferencing requests). For example, weight values can be applied to the latency, cost, instance type, batch size, or other value (e.g., in the table 222) to determine the weighted sum 220 of various rows in the table. Continuing this example, the row with the greatest value in the weighted sum 220 can be selected and the computing instance type and/or batch size associated with the row is used to execute the inferencing service and/or processing inferencing requests.

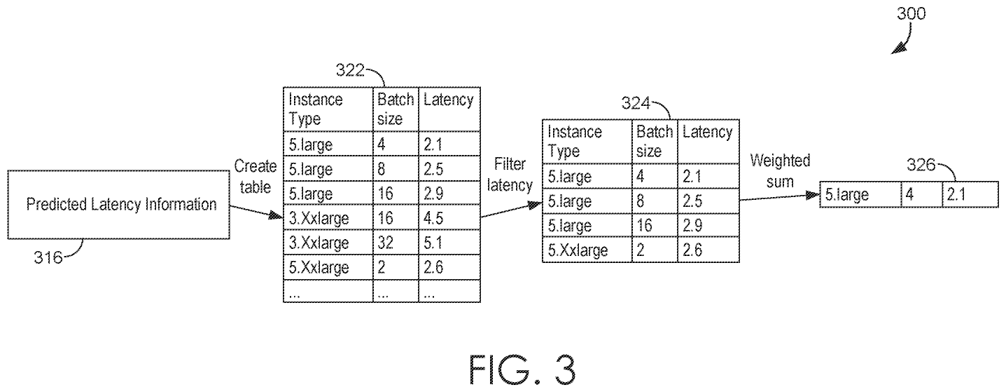

FIG. 3 illustrates an environment 300 in which latency information is predicted by a prediction machine learning model and used to determine a computing instance configuration and/or batch size to use to process inferencing requests, in accordance with at least one embodiment. In various embodiments, a training dataset is generated and used to train the prediction machine learning model, which estimates or otherwise predicts various metrics for computing instances such as latency. For example, the prediction machine learning model 326 generated predicted latency information 316, which includes latency values associated with a particular computing instances executing a particular machine learning model to process inferencing requests of a particular batch size. In various embodiments, the prediction machine learning model 326 takes as an input a set of possible instance types, a set of possible batch sizes, a set of model parameters, and a number of FLOPs for the particular machine learning model and generates the latency information.

In various embodiments, a table 322 is created using the predicted latency information 316. In one example, the latency tool 104, as described above in connection with FIG. 1, obtains the latency values included in the predicted latency information 316 and generates the table 322. As illustrated in FIG. 3, the table 322 include three columns including instance type, batch size, and latency. In an embodiment, the instance type indicates a particular configuration of computing instance useable to execute the particular machine learning model. In addition, the batch size indicates a number of data objects to be processed by the particular machine learning model included in an inferencing request, in accordance with an embodiment. Further, as illustrated in FIG. 3, in an embodiment, the table 322 include a latency column which indicates the predicted latency value associated with the instance type and the batch size. In one example, the instance type “5.large” when processing an inferencing request of batch size “4” has a predicted latency of “2.1” (e.g., 2.1 seconds).

In various embodiments, the table 322 is filtered to generate a filtered table 324. For example, any rows of the table 322 including a latency value above three seconds are filtered (e.g., removed from the table) to generate the filtered table 324. In an embodiment, the user provides a threshold value and/or upper bound on latency that is used to generate the filtered table 324. Furthermore, in various embodiments, a weighted sum for the rows in the filtered table 324 is determined and the row 326 with the highest value is selected to recommend and/or execute the particular machine learning model (e.g., execute an inferencing service). For example, weight values for latency, cost, efficiency, resource utilization, or other metrics can be applied to the values in the filtered table 324, and the weighted sum is calculated to determine the optimal combination of instance type and batch size. In various embodiments, the user provides the weight values used to calculate or otherwise determine the weight sum. In one example, the user provides percentage values indicating a preference between various metrics (e.g., sixty percent latency and forty percent cost).

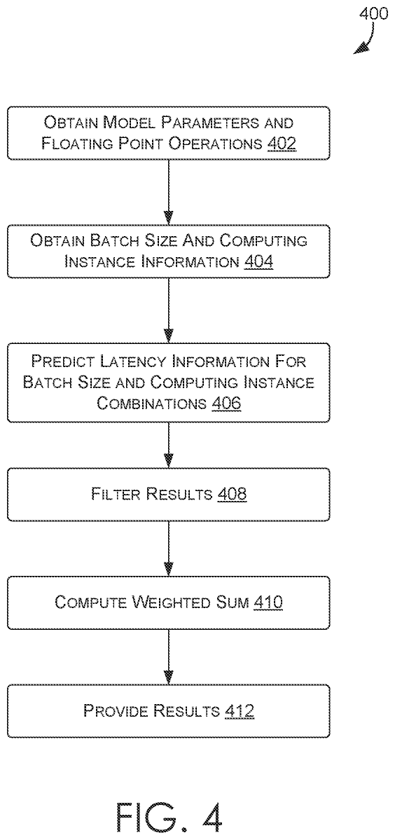

Turning now to FIGS. 4-6, the methods 400, 500, and 600 can be performed, for instance, by the latency tool 104 of FIG. 1. Each block of the methods 400, 500, and 600 and any other methods described herein comprise a computing process performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few.

With initial reference to FIG. 4, FIG. 4 is a flow diagram showing a method 400 for determining a computing instance and/or batch size based on latency information generated by a prediction machine learning model in accordance with at least one embodiment. As shown at block 402, the system implementing the method 400 obtains model parameters and floating point operations (FLOPs). As described above in connection with FIG. 1, in various embodiments, the user provides information indicating the model parameters and the FLOPs for the model to be used to process the inferencing requests. In other examples, the user provides the model, and the system implementing the method 400 determines the model parameters and the FLOPs for the model to be used to perform inferencing operations.

At block 404, the system implementing the method 400 obtains batch size and computing instance information. For example, the user provides information indicating various batch sizes or other information associated with the inferencing requests. In addition, in various embodiments, the system implementing the method 400 obtains computing instance information indicating configuration information for a set of computing instances available to execute the model. For example, the system implementing the method 400 obtains system architecture information for a set of computing devices that are useable to execute the model.

At block 406, the system implementing the method 400 predicts latency information associated with the batch sizes and computing instances combinations. For example, the system implementing the method 400 causes the prediction machine learning model to generate predicted latency times for all combinations of computing instances (e.g., different configurations of computing instances) and batch sizes (e.g., different batch sizes for inferencing requests). As described above, the latency information, in various embodiments, indicates an amount of time a computing instances take to process a set of inferencing requests of a batch size using the model.

At block 408, the system implementing the method 400 filters the results of the prediction machine learning model. In one example, the results of the prediction machine learning model are filtered to remove any latency values above a threshold. At block 410, the system implementing the method 400 computes the weighted sum of the filtered results. For example, as described above, the user provides a weighting between various metrics associated with the set of computing instances such as latency, cost, utilization, efficiency, or other metrics. Continuing this example, the system implementing the method 400 computes the weighted sum (e.g., for each row of the table described above) based on the weighting provided by the user. In various embodiments, where the prediction machine learning model predicts additional metrics such as utilization or efficiency the user can provide a weighting for these additional metrics.

At block 412, the system implementing the method 400 provides the results of computing the weighted sum. In one example, the latency tool obtains the results and selects the combination of computing instance and batch size that has the highest weighted sum value to process the inferencing requests. Although not illustrated in FIG. 4 for simplicity, the method 400 can be repeated periodically and/or aperiodically. For example, the method 400 can be repeated at the expiration of a sliding window (e.g., five minute intervals) based on an expected number of inferencing requests.

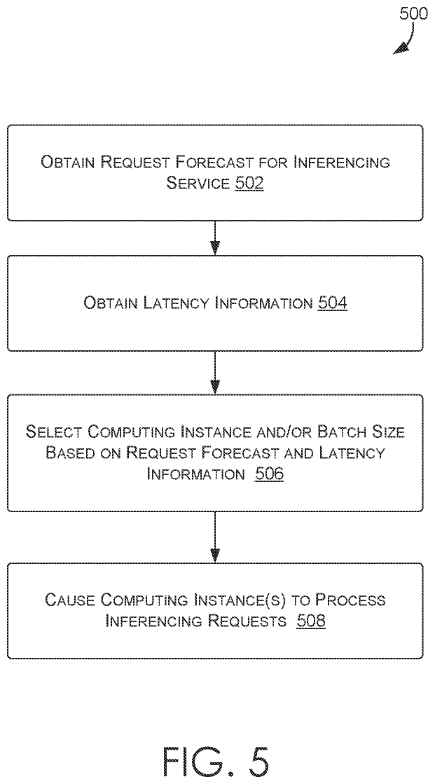

FIG. 5 is a flow diagram showing a method 500 for selecting a computing instance and/or batch size based on a request forecast and latency information generated by a prediction machine learning model in accordance with at least one embodiment. At block 502, the system implementing the method 500 obtains a request forecast for an inferencing service. For example, as described above, a forecasting service generates a prediction indicating a number of inferencing requests expected over an interval of time.

At block 504, the system implementing the method 500 obtains latency information. As described above, in one example, the prediction machine learning model generates latency information for a set of computing instances and batch sizes based on a model used to perform inferencing (e.g., the model used by the inferencing service). In an embodiment, the latency information is generated by the prediction machine learning model and stored by the system implementing the method 500. In one example, the latency information 504 in stored and used to determine a computing instance and a batch size for a plurality of request forecasts. At block 506, the system implementing the method 500 selects a computing instance and/or batch size based on the request forecast and the latency information. In one example, the request forecast indicates that sixteen inferencing requests are predicted in the next sliding window, the system implementing the method 500 then selects a computing instance and/or batch size that optimizes one or more metrics (e.g., latency, cost, etc.). In various embodiments, as described above, the user provides a specific goal and/or selects between metrics to optimize and a weight sum of the latency information is determined in order to select the computing instance and/or batch size.

At block 508, the system implementing the method 500 causes computing instances to processes the inferencing requests. For example, the latency tool causes a computing resource service provider to instantiate a set of computing instances having the configuration of the selected computing instance. In another example, the latency tool causes an application (e.g., an inferencing service front end) to generate inferencing request of the selected batch size. In various embodiments, the method 500 can be repeated at various time intervals periodically and/or aperiodically. For example, the forecast service generates request forecast for five minute intervals and the method 500 can be repeated in response to receiving other otherwise obtaining the request forecast.

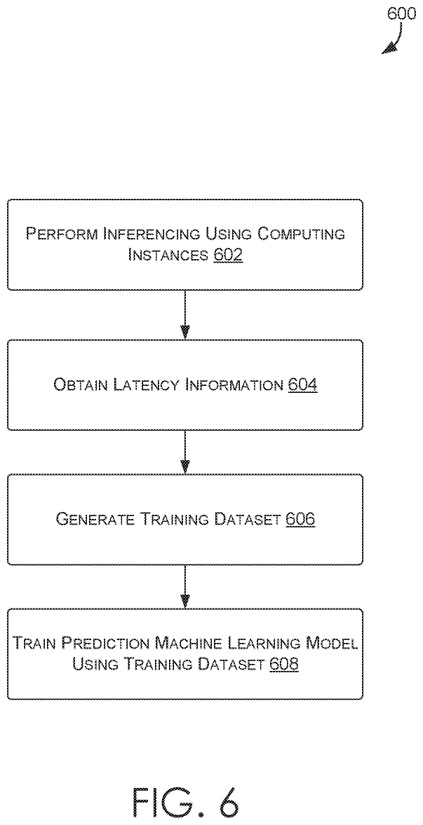

FIG. 6 is a flow diagram showing a method 600 for generating a training dataset to train a prediction machine learning model in accordance with at least one embodiment. At block 602, the system implementing the method 600 perform inferencing operations of a plurality of machine learning models on a plurality of computing instances using a plurality of batch sizes. For example, a plurality of different computing instances are instantiated and used to execute the plurality of machine learning models and latency information and/or other metrics are collected during execution. The computing instances, in an embodiment, includes different configurations such as GPU architecture and number of processors. At block 604, the system implementing the method 600 obtains latency information and/or other system performance metrics. For example, the computing instances include an application that collects time-series data during execution of the plurality of machine learning models.

At block 606, the system implementing the method 600 generates a training dataset. In various embodiments, the latency information is combined with the corresponding computing instance configuration information and the batch size information. For example, the training dataset includes FLOPs associated with the plurality of models, model parameters of the plurality of models, batch sizes, latency, and computing instance information (e.g., instance type and/or instance configuration information). At block 608, the system implementing the method 600 trains the prediction machine learning model using the training dataset. For example, the prediction machine learning model is provided with the training dataset and trained to predict latency information given an input. Continuing this example, the input includes FLOPs associated with the plurality of models, model parameters of the plurality of models, batch sizes, and computing instance information.

Having described embodiments of the present invention, FIG. 7 provides an example of a computing device in which embodiments of the present invention may be employed. Computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what may be one or more busses (such as an address bus, data bus, or combination thereof). Although the various blocks of FIG. 7 are shown with lines for the sake of clarity, in reality, delineating various components is not so clear, and metaphorically, the lines would more accurately be gray and fuzzy. For example, one may consider a presentation component such as a display device to be an I/O component. Also, processors have memory. The inventors recognize that such is the nature of the art and reiterate that the diagram of FIG. 7 is merely illustrative of an exemplary computing device that can be used in connection with one or more embodiments of the present technology. Distinction is not made between such categories as “workstation,” “server,” “laptop,” “handheld device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or nonvolatile memory. As depicted, memory 712 includes instructions 724. Instructions 724, when executed by processor(s) 714 are configured to cause the computing device to perform any of the operations described herein, in reference to the above discussed figures, or to implement any program modules described herein. The memory may be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which may be built in. Illustrative components include a microphone, joystick, game pad, satellite dish, scanner, printer, wireless device, etc. I/O components 720 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on computing device 700. Computing device 700 may be equipped with depth cameras, such as stereoscopic camera systems, infrared camera systems, RGB camera systems, and combinations of these, for gesture detection and recognition. Additionally, computing device 700 may be equipped with accelerometers or gyroscopes that enable detection of motion. The output of the accelerometers or gyroscopes may be provided to the display of computing device 700 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments may be practiced with only some of the described aspects. For purposes of explanation, specific numbers, materials, and configurations are set forth in order to provide a thorough understanding of the illustrative embodiments. However, it will be apparent to one skilled in the art that alternate embodiments may be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules may be merged, broken into further sub-parts, and/or omitted.

The phrase “in one embodiment” or “in an embodiment” is used repeatedly. The phrase generally does not refer to the same embodiment; however, it may. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A method comprising:
obtaining an input to a prediction machine learning model, the input indicating a set of model parameters associated with a machine learning model and a number of floating point operations (FLOPS) associated with performing inferencing operations using the machine learning model;
determining a set of computing instances capable of executing the machine learning model and a set of batch sizes associated with inferencing requests;
causing the prediction machine learning model to output latency information for the set of computing instances and the set of batch sizes, the latency information indicating an interval of time to process an inferencing request of a batch size of the set of batch sizes by a computing instance of the set of computing instances;
determining a set of weight sum values associated with the set of computing instances based on the latency information; and
causing an indication of the set of weight sum values associated with the set of computing instances to be displayed in a user interface.

2. The method of claim 1, wherein the method further comprises selecting a first computing instance of the set of computing instances to execute the machine learning model, where based at least in part on a first weight sum value of the set of weight sum values.

3. The method of claim 2, wherein the first weight sum value is greater than at least one other weight sum value of the set of weight sum values.

4. The method of claim 2, wherein the method further comprises training the prediction machine learning model using a training dataset including a set of metrics obtained by at least causing the set of computing instances to execute a set of machine learning models performing inferencing operations.

5. The method of claim 1, wherein the method further comprises:
obtaining a forecast indicating a number of inferencing requests expected over a second interval of time; and
determining the batch size of the set of batch sizes to use to process the inferencing requests over the second interval of time based on the latency information.

6. The method of claim 1, wherein the method further comprises filtering the latency information to remove computing instances of the set of computing instances associated with a latency value over a threshold latency value.

7. The method of claim 1, wherein the set of model parameters associated with the machine learning model and the number of floating point operations (FLOPS) are determined based at least in part on the machine learning model.

8. A non-transitory computer-readable medium storing executable instructions embodied thereon, which, when executed by a processing device, cause the processing device to perform operations comprising:
causing a first machine learning model to predict latency information associated with a set of computing instances executing an inferencing request associated with a set of batch sizes, the first machine learning model taking as inputs a set of parameters of a second machine learning model and a number of flopping point operations (FLOPs) associated with the second machine learning model;
determining a computing instance of the set of computing instances and a batch size of the set of batch sizes to execute an inferencing service using the second machine learning model based on the latency information; and
causing the computing instance to execute the second machine learning model and process inferencing requests including a number of data objects corresponding to the batch size.

9. The medium of claim 8, wherein the processing device further performs operations comprising:
generating a set of weighted sums associated with the set of computing instances and the set of batch sizes based on the latency information; and
wherein determining the computing instance is further determined based on the set of weighted sums.

10. The medium of claim 9, wherein the set of weighted sums is determined based on a first weight value associated with latency of the set of computing instances and a second weight value associated with cost of the set of computing instances.

11. The medium of claim 8, wherein the latency information indicates an amount of time computing instances of the set of computing instances take to process an inferencing request of batch sizes of the set of batch sizes using the second machine learning model.

12. The medium of claim 8, wherein the processing device further performs operations comprising:
obtaining a forecast predicting a number of inferencing requests over an interval of time; and
wherein determining the batch size is further determined based on the forecast.

13. The medium of claim 8, wherein the processing device further performs operations comprising filtering computing instances of the set of computing instances based on a latency threshold.

14. The medium of claim 8, wherein the first machine learning model is a regression model.

15. The medium of claim 8, wherein the processing device further performs operations comprising training the first machine learning model based on a training dataset including latency obtained from the set of computing instances executing inferencing requests using a set of machine learning models, parameters associated with the set of machine learning models, and FLOPS associated with the set of machine learning models.

16. A system comprising:
a memory component; and
a processing device coupled to the memory component, the processing device to perform operations comprising:
obtaining a training dataset including latency information obtained from a plurality of computing instances executing a plurality of inferencing requests of a plurality of batch sizes using a plurality of machine learning models;
training a prediction machine learning model to determine latency for a set of computing instances and a set of batch sizes using the training dataset;
providing the prediction machine learning model to a latency tool; and
causing the latency tool to determine a computing instance and a batch size for processing a set of inferencing requests using a machine learning model based at least in part on a result of the prediction machine learning model, the prediction machine learning model taking as an input information associated with the machine learning model.

17. The system of claim 16, wherein the information associated with the machine learning model includes at least one of: a number of floating point operations (FLOPs), a number of layers, a number of activations, and a number of parameters.

18. The system of claim 16, wherein the latency information indicates an amount of time a first computing instance of the plurality of computing instances takes to process an inferencing request of a first batch size of the plurality of batch sizes.

19. The system of claim 16, wherein the prediction machine learning model is a random forest regression model.

20. The system of claim 16, wherein causing the latency tool to determine the computing instance and the batch size further comprises determining the computing instance and the batch size based on a forecast indicating a number of inferencing requests over an interval of time.
